(19) United States
(12) Patent Application Publication
(10) Pub. No.: US 2022/0231301 A1
(43) Pub. Date: Jul. 21, 2022

(54) ELECTROCHEMICAL CELL AND METHOD OF PRODUCTION THEREOF

(71) Applicant: VARTA Microbattery GmbH, Ellwangen Jagst (DE)

(72) Inventors: Bernd Beck, Munningen (DE); David Ensling, Ellwangen (DE); Rainer Hald, Ellwangen (DE); Edward Pytlik, Ellwangen (DE); Stefan Stock, Rainau Dalkingen (DE)

(21) Appl. No.: 17/611,979

(22) PCT Filed: May 19, 2020
(86) PCT No.: PCT/EP2020/063874

§ 371 Date: Nov. 17, 2021

(30) Foreign Application Priority Data
May 24, 2019 (EP) 19176361.4

(51) Int. Cl. H01M 4/66; H01M 10/0525; H01M 50/40

(52) U.S. Cl. CPC H01M 4/662; H01M 2004/028; H01M 50/40; H01M 10/0525

(57) ABSTRACT

An electrochemical cell including an electrode-separator composite having an anode, at least one separator and a cathode, wherein the anode comprises an anode current collector having a surface consisting of at least one metal and has been laden with at least one layer of a negative active electrode material, the cathode comprises a cathode current collector having a surface consisting of at least one metal and has been laden with at least one layer of a positive active electrode material, and the surface of the anode current collector and/or the surface of the cathode current collector comprises at least one clear region not laden with the respective active electrode material, and in the at least one clear region the surface of the anode current collector and/or the surface of the cathode current collector has been coated with a support material of greater thermal stability than the surface coated therewith.

### TECHNICAL FIELD

This disclosure relates to an electrochemical cell having an electrode-separator composite comprising an anode, at least one separator and a cathode. Background

Cells are known in principle, for example, from DE 10 2009 060 800 A1. DE '800 describes cylindrical windings of electrode-separator composites inserted into cylindrical metal housings. The electrodes are electrically contacted using current collectors laden with active electrode materials. The current collectors are each welded to a metal foil that functions as a separate current conductor and electrically connects the current collectors to the housing.

The procedure described in DE '800 for electrical contact connection of the electrodes is efficient and inexpensive. However, it has disadvantages in particular applications. One problem is, for example, the electrical connection of the electrodes via the metal foils. If high currents are to be stored or released within a short time by electrodes connected in this way, the metal foils are heated very significantly.

WO 2017/215900 A1 discloses an electrochemical cell of the generic type, in which the electrode-separator composite and its electrodes are in strip form and take the form of a winding or stack. The electrodes each have current collectors laden with electrode material. Electrodes of opposite polarity are arranged offset from one another within the electrode-separator composite such that longitudinal edges of the current collectors of the positive electrode protrude from the winding or stack on one side, and longitudinal edges of the current collectors of the negative electrodes protrude on a further side. The current collectors are electrically contacted by virtue of the cell having at least one contact plate that adjoins one of the longitudinal edges to result in a linear contact zone. The contact plate is bonded by welding to the longitudinal edge along the linear contact zone. This makes it possible to electrically contact the current collector and hence also the corresponding electrode over its entire length. This very distinctly lowers the internal resistance within the cell described. The occurrence of large currents can consequently be dealt with very much better than, for example, by the cells of DE '800.

However, a problem with the cells described in WO '900 is that it is very difficult to weld the longitudinal edges and the contact plates to one another. In relation to the contact plates, the current collectors of the electrodes are of markedly low thickness. The edge region of the current collectors is therefore extremely mechanically sensitive and can be unintentionally pressed down or melted down during the welding operation. In addition, there can be melting of separators of the electrode-separator composite when the contact plates are being welded on. In extreme cases, this can result in short circuits.

It could therefore be helpful to provide electrochemical cells of the generic type that feature not only improved current durability but also improved producibility.

### SUMMARY

We provide an electrochemical cell including an electrode-separator composite having an anode, at least one separator and a cathode, wherein the anode comprises an anode current collector having a surface consisting of at least one metal and has been laden with at least one layer of a negative active electrode material, the cathode comprises a cathode current collector having a surface consisting of at least one metal and has been laden with at least one layer of a positive active electrode material, and the surface of the anode current collector and/or the surface of the cathode current collector comprises at least one clear region not laden with the respective active electrode material, and in the at least one clear region the surface of the anode current collector and/or the surface of the cathode current collector has been coated with a support material of greater thermal stability than the surface coated therewith.

We also provide battery including at least two of the electrochemical cells.

We further provide a method of producing the electrochemical cells including: a) providing an anode comprising an anode current collector having a surface that consists of at least one metal and has been laden with at least one layer of a negative active electrode material, b) providing a cathode comprising a cathode current collector having a surface that consists of at least one metal and has been laden with at least one layer of a positive active electrode material, and c) manufacturing an electrode-separator composite comprising an anode, at least one separator and a cathode using the anode provided and the cathode provided, wherein c) is preceded or followed by d) coating a clear region on the surface of the anode current collector that has not been laden with the negative active electrode material and/or a clear region on the surface of the cathode current collector that has not been laden with the positive active electrode material with a support material of greater thermal stability than the surface coated therewith.

### BRIEF DESCRIPTION OF THE DRAWINGS

FIG. 1 shows a schematic perspective view of a spiral winding.

FIG. 2 shows a schematic plan view of a contact plate.

FIG. 3 shows a schematic perspective view of contact plates applied to a winding.

FIG. 4 shows a schematic perspective view of contact plates welded to a winding.

FIG. 5 shows a schematic cross section of an electrode-separator composite.

FIG. 6 shows a schematic cross section of the assembly a winding.

FIG. 7 shows a schematic cross section of the structure in FIG. 4.

FIG. 8 shows a schematic top view of an anode from FIG. 6.

### DETAILED DESCRIPTION

Our electrochemical cells always have a-d that follow directly:
a. the cell comprises an electrode-separator composite having an anode, at least one separator and a cathode,
b. the anode comprises an anode current collector having a surface that consists of at least one metal and has been laden with at least one layer of a negative active electrode material,
c. the cathode comprises a cathode current collector having a surface that consists of at least one metal and has been laden with at least one layer of a positive active electrode material, and
d. the surface of the anode current collector and/or the surface of the cathode current collector comprises at least one clear region not laden with the respective active electrode material.

The cell especially has:
e. in the at least one clear region the surface of the anode current collector and/or the surface of the cathode current collector has been coated with a support material of greater thermal stability than the surface coated therewith.

The intended meaning of “greater thermal stability” is that the support material remains in the solid state at a temperature at which the surface melts. It thus either has a higher melting point than the surface or does not sublime or break down until the temperature at which the surface has already melted.

Preferably, both the surface of the anode current collector and the surface of the cathode current collector have a clear region not laden with the respective active electrode material. It is preferable that both the clear region on the surface of the anode current collector and the clear region on the surface of the cathode current collector are coated with the support material. Particular preference is given to using the same support material for each of the regions.

The cell is preferably a secondary cell, i.e. a rechargeable cell. Useful active electrode materials for the cell therefore preferably include materials that can be used in secondary electrochemical cells.

More preferably, the electrochemical cell is a lithium ion cell. Useful active electrode materials in this case are all materials that can absorb lithium ions and release them again. The negative active electrode material may, for example, be a carbon-based material such as graphitic carbon or another material capable of intercalation of lithium ions. It is also possible to use metals and semimetals that can form intermetallic phases with lithium, for example, silicon, as negative electrode material, especially also in a mixture with a carbon-based material capable of intercalation of lithium ions. Examples of useful positive active electrode materials include lithium-metal oxide compounds and lithium-metal phosphate compounds such as LiCoO₂ and LiFePO₄. Further suitable materials include those based on NMC (lithium nickel manganese cobalt oxide), LTO (lithium titanate) and based on NCA (lithium nickel cobalt aluminum oxide).

Further preferably, the cell may be a nickel metal hydride cell that has a hydrogen storage alloy as active electrode material on the negative electrode side and nickel hydroxide/nickel oxyhydroxide on the positive electrode side.

In addition, the electrodes in the cell may be designed like the electrodes of the systems described in WO 2016/005529 A1 and in WO 2016/005528 A2. Those publications describe systems in which the positive electrode includes an active electrode material based on nickel oxyhydroxide/nickel hydroxide, while the negative electrode contains, as active electrode material, a mixture of activated carbon and hydrogen storage alloy or a mixture of activated carbon and iron in metallic and/or oxidized form.

The active electrode materials, both on the positive electrode side and on the negative electrode side, are preferably in particulate form.

As well as the active electrode materials and the current collectors, the electrodes of the cells may also have further components. In particular, these are typically electrode binders and conductors. The electrode binders assure the mechanical stability of the electrodes and ensure the electrical and mechanical contacting of active electrode material particles to one another and to the current collector. Conductors such as carbon black serve to increase the electrical conductivity of the electrodes.

In general, the electrode-separator composite comprises an electrolyte with which the electrodes are impregnated and which assures the ion current between the electrodes of the cell that occurs in the event of charging or discharging of the cell. In lithium ion batteries, electrolytes used are usually mixtures of organic carbonates containing a conductive lithium salt. In nickel metal hydride cells and the cells described in WO '529and in WO '528, electrolytes used are preferably aqueous alkaline solutions.

The at least one separator prevents direct contact between electrodes of opposite polarity. At the same time, it must be permeable to ions that migrate back and forth between the electrodes in the course of charging and discharging operations. Useful separators for the electrode-separator composite of the cell especially include separators made of porous polymer films, for example, of a polyolefin or a polyether ketone. It is also possible to use nonwovens and weaves made of these materials.

In general, the electrode-separator composite comprises the electrodes and the at least one separator in the sequence of positive electrode/separator/negative electrode. Preferably, the composite is in a form with two separators, for example with the possible sequences of negative electrode/first separator/positive electrode/second separator or positive electrode/first separator/negative electrode/second separator.

In some configurations, the electrode-separator composite may also have more than one positive or more than one negative electrode. For example, it is possible that the composite has the sequence of negative electrode/first separator/positive electrode/second separator/negative electrode or the sequence of positive electrode/first separator/negative electrode/second separator/positive electrode.

Within the composite, the electrodes and the separators are preferably connected to one another via lamination and/or adhesive bonding.

The current collectors in the electrodes serve to electrically contact the active electrode materials over a maximum area.

More preferably, the current collectors of the cell and hence also the cell itself have at least one of the additional a. to f that follow directly:
a. the at least one metal of which the surface of the anode current collector consists comprises at least one member from the group comprising copper, a copper alloy, titanium, a titanium alloy, nickel, a nickel alloy and stainless steel,
b. the anode current collector consists of the at least one metal,
c. the anode current collector is a metal foil, a metal sponge, a textile fabric or an expanded metal,
d. the at least one metal of which the surface of the cathode current collector consists comprises at least one member from the group comprising aluminum, an aluminum alloy, titanium, a titanium alloy and stainless steel,
e. the cathode current collector consists of the at least one metal, and
f. the cathode current collector is a metal foil, a metal sponge, a textile fabric or an expanded metal.

Preferably, a. to c. directly above are all implemented simultaneously in combination with one another. Further preferably, d. to f. directly above are all implemented simultaneously in combination with one another. Particularly preferably, a. to f. directly above are all implemented simultaneously in combination with one another.

More preferably, the anode current collector consists of copper or a copper alloy, while the cathode current collector simultaneously consists of aluminum or an aluminum alloy.

As well as current collectors consisting entirely of the at least one metal, however, it is also entirely possible to use current collectors in which the surface consisting of the at least one metal surrounds a nonmetallic structure, for example a textile fabric consisting of filaments of glass or plastic. The term “textile fabric” especially means nonwovens, weaves, meshes and knits.

Particularly preferably, the cathode current collector consists of an aluminum foil, preferably having a thickness of 5 μm to 30 μm. More preferably, the anode current collector consists of copper foil, preferably having a thickness of 5μm to 15 μm, or of nickel foil, preferably having a thickness of 3 μm to 10 μm.

Particularly preferably, the current collectors of the cell and hence also the cell itself have at least one of the additional a. to d. that follow directly:
a. the anode current collector has two flat sides separated from one another by at least one edge,
b. the anode current collector is laden with the at least one layer of the negative active electrode material on the two flat sides,
c. the surface of the anode current collector comprises a clear region coated with the support material, divided into two subregions on the two flat sides thereof, and
d. the two subregions of the anode current collector are coated with the support material.

More preferably, a. to d. directly above are all implemented simultaneously in combination with one another.

Particularly preferably, the current collectors of the cell and hence also the cell itself have at least one of the additional a. to d. that follow directly:
a. the cathode current collector has two flat sides separated from one another by at least one edge,
b. the cathode current collector is laden with the at least one layer of the positive active electrode material on the two flat sides,
c. the surface of the cathode current collector comprises a clear region coated with the support material, divided into two subregions on the two flat sides thereof, and
d. the two subregions of the cathode current collector are coated with the support material.

More preferably, a. to d. directly above are all implemented simultaneously in combination with one another.

The clear region or the subregions may be wholly or partly coated with the support material. The at least one edge that separates the flat sides and hence also the two subregions from one another, by contrast, is preferably not coated with the support material.

Both the cathode current collector and the anode current collector may have the flat sides, and clear regions coated with the support material, divided into two subregions. This is especially true when the cathode current collector and the anode current collector used are each a foil or another of the substrates mentioned, for instance, the textile fabrics mentioned. In such substrates, the surface area of the current collectors corresponds essentially to the areas of the two flat sides. The at least one edge can be neglected in the quantitative registration of the surface. Owing to the low thickness of the substrates mentioned, it generally does not account any relevant proportion of the surface of the current collectors.

More preferably, both the two subregions on the cathode current collector and the two subregions on the anode current collector are coated with the support material.

More preferably, not only is the at least one clear region on the surface of the anode current collector and/or the surface of the cathode current collector coated with the support material. Instead, it may be preferable for the layers of the positive and negative electrode materials simultaneously also to be coated with the support material. For processing reasons, it is simpler in an application of the support material to the at least one clear region to apply the support material to the layers of the electrode material as well, since masking of these layers may otherwise be necessary.

The support material may in principle be a metal or a metal alloy, provided that it has a higher melting point than the metal of which the surface coated with the support material consists. In many configurations, however, the cell preferably has at least one of the additional a. to c. that follow directly:
a. the support material is a nonmetallic material,
b. the nonmetallic material is a ceramic material, a glass-ceramic material or a glass, and
c. the ceramic material is aluminum oxide (Al₂O₃), titanium oxide (TiO₂), titanium nitride (TiN), titanium aluminum nitride (TiAlN) or titanium carbonitride (TiCN).

The term “ceramic material” should be interpreted broadly. This is especially understood to mean carbide, nitride, oxide, silicide or mixtures and derivatives of these compounds. The support material more preferably takes the form according to c. directly above.

The term “glass-ceramic material” especially means a material comprising crystalline particles embedded into an amorphous glass phase.

The term “glass” in principle means any inorganic glass that satisfies the above-defined thermal stability criteria and is chemically stable to any electrolyte present in the cell.

More preferably, the anode current collector consists of copper or a copper alloy, while the cathode current collector simultaneously consists of aluminum or an aluminum alloy, and the support material is aluminum oxide or titanium oxide.

In a first particularly preferred configuration of the cell, it has at least one of the additional a. to g. that follow directly:
a. the electrode-separator composite is in the form of a winding with two terminal end faces,
b. the electrode-separator composite and the at least one separator comprised therein, the electrodes comprised therein and hence also the anode current collector and the cathode current collector are in strip form and each have two longitudinal edges,
c. the two terminal end faces of the electrode-separator composite are formed by the longitudinal edges of the at least one separator,
d. both the surface of the anode current collector and the surface of the cathode current collector comprise a clear region not laden with active electrode material,
e. the clear region on the surface of the anode current collector is an edge region in strip form along one of its two longitudinal edges,
f. the clear region on the surface of the cathode current collector is an edge region in strip form along one of its two longitudinal edges, and
g. the anode in strip form and the cathode in strip form are arranged offset from one another within the electrode-separator composite such that
   the longitudinal edge of the anode current collector together with the clear region of the anode current collector protrudes from one of the two terminal end faces, and

the longitudinal edge of the cathode current collector together with the clear region of the cathode current collector protrudes from the other of the two terminal end faces.

Preferably, a. to g. directly above are all implemented simultaneously in combination with one another.

In this wound configuration of the electrode-separator composite too, the current collectors preferably have two flat sides and have preferably been laden on each side with the layers of the respective electrode materials. More preferably, both the edge region on the surface of the anode current collector and the edge region on the surface of the cathode current collector are divided by the respective longitudinal edge along which they extend into two subregions each in strip form, all of which are coated with the support material. More preferably, the subregions are each coated with a strip of the support material. The current collectors in that case are thus not just laden with the respective electrode materials on both sides but also coated with the support material on both sides. The longitudinal edges are preferably not coated with the support material.

In the production of electrode-separator composites, it is typically ensured that electrodes and current collectors are combined with one another such that there is no protrusion on one side of current collectors of opposite polarity since this can increase the risk of a short circuit. In the offset arrangement described, however, the risk of a short circuit is minimized since the current collectors of opposite polarity protrude from mutually opposite end faces of the winding.

The winding preferably has a maximum height of 30 mm to 100 mm and a maximum diameter of 10 mm to 45 mm.

The anode and cathode current collectors in strip form preferably have a length of 50 mm to 300 cm, a width of 30 mm to 100 mm and a thickness of 30 μm to 200 μm.

The edge regions in strip form and the subregions in strip form preferably have a width of 0.5 mm to 5 mm.

Preferably, the winding is a cylindrical winding. In further configurations, the winding may alternatively be a prismatic flat winding. As is well known, the structure of a prismatic flat winding is similar to the structure of a cylindrical winding. However, the electrode-separator composite for production of a flat winding is wound not in a spiral about an axis but in a flat manner such that the composite processed to give the flat winding comprises planar, uncurved sections that lie one on top of another in the manner of a stack in the flat winding.

In a second particularly preferred configuration of the cell, this has at least one of the additional a. to e. that follow directly:
a. the electrode-separator composite, together with at least one further identical electrode-separator composite, is part of a stack in which the at least two electrode-separator composites are stacked one on top of another,
b. the at least two electrode-separator composites and their anodes, cathodes and separators and hence also their anode current collectors and the cathode current collectors each have at least one longitudinal edge,
c. the anode current collectors each have a clear region, especially in the form of an edge region in the form of a strip, along their longitudinal edge or one of their longitudinal edges,
d. the cathode current collectors each have a clear region, especially in the form of an edge region in the form of a strip, along their longitudinal edge or one of their longitudinal edges, and
e. the anodes and the cathodes of the at least two electrode-separator composites are arranged offset from one another within the stack and hence also within the composites such that
   the clear regions of the anode current collectors overlap on one side of the stack, and
   the clear regions of the cathode current collectors overlap on a further side of the stack.

Preferably, a. to e. directly above are all implemented simultaneously in combination with one another.

In this configuration in the form of a stack as well, the current collectors preferably have two flat sides and are preferably each laden on either side with the layers of the respective electrode materials. More preferably, both the edge region on the surface of the anode current collector and the edge region on the surface of the cathode current collector are divided by the respective longitudinal edge along which they extend into two subregions, each in the form of strips, all of which are coated with the support material. More preferably, the subregions are each coated with a strip of the support material. The current collectors are then thus not only laden with the respective electrode materials on both sides but also coated with the support material on both sides. The longitudinal edges are preferably not coated with the support material.

The stack preferably has a maximum height of 5 mm to 20 mm.

The anode and cathode current collectors, like the electrodes, are preferably in rectangular form. They more preferably have a length of 100 mm to 300 mm, a width of 50 mm to 150 mm and a thickness of 50 μm to 250 μm.

The edge regions in strip form and the subregions in strip form preferably have a width of 0.5 mm to 5 mm.

It is preferable that the cell has at least one of the additional a. to d. that follow directly:
a. the coating of the at least one clear region with the support material has a thickness of 0.015 to 1.0 mm, preferably 0.05 to 0.2 mm,
b. the at least one layer of the negative electrode material on the anode current collector has a thickness of 0.03 to 1.0 mm, preferably 0.1 to 0.2 mm,
c. the at least one layer of the positive electrode material on the cathode current collector has a thickness of 0.03 to 1.0 mm, preferably 0.1 to 0.2 mm, and
d. the thickness of the coating with the support material on the anode current collector or cathode current collector is 1% to 100% of the thickness of the layer of the electrode material present thereon.

Preferably, a. to d. directly above are all implemented simultaneously in combination with one another.

The thickness of the coating with the support material on the anode current collector or cathode current collector may be 5% to 50% of the thickness of the layer of the electrode material present thereon, more preferably 2% to 25%.

The cell more preferably has at least one of the additional a. to c. that follow directly:
a. the anode current collector and the cathode current collector have two flat sides and clear regions coated with the support material, subdivided into two subregions,
b. the cell comprises a first electrical conductor welded onto the edge of the anode current collector, and
c. the cell comprises a second electrical conductor welded onto the edge of the cathode current collector.

Preferably, a. to d. directly above are all implemented simultaneously in combination with one another.

The electrical conductors can especially be welded on by laser welding or TIG welding (tungsten-inert gas welding).

Preferably, the cell additionally has at least one of a. to c. that follow directly:
a. the cell has an electrode-separator composite in the form of a winding with the two terminal end faces and the anode current collector in strip form and the cathode current collector in strip form, each with the two longitudinal edges,
b. the first electrical conductor is welded onto the longitudinal edge of the anode current collector in strip form, along which the clear region of the anode current collector extends, and
c. the second electrical conductor is welded onto the longitudinal edge of the cathode current collector in strip form, along which the clear region of the cathode current collector extends.

Preferably, a. to c. directly above are all implemented simultaneously in combination with one another.

In a configuration according to a. to c. directly above, the cell additionally has at least one of a. to d. that follow directly:
a. the first electrical conductor is a metallic contact plate,
b. the second electrical conductor is a metallic contact plate,
c. the first metallic contact plate lies flat against the end face of the winding from which the longitudinal edge to which the contact plate is welded protrudes, and
d. the second metallic contact plate lies flat against the end face of the winding from which the longitudinal edge to which the contact plate is welded protrudes.

Preferably, a. to d. directly above are all implemented simultaneously in combination with one another.

The excess of the current collectors that results from the offset arrangement may be exploited by contacting them over a large area by the contact plates. By the contact plates, it is possible to electrically contact the current collectors and hence also the corresponding electrodes over their entire length. This is because the flat laying on the end faces of the winding results in linear contact zones. If the electrode-separator composite is in the form of a spiral winding, for example, the longitudinal edges of the anode current collector and of the cathode current collector that protrude from the end faces of the winding likewise have a spiral geometry. The situation is then analogous for the linear contact zones along which the contact plates are welded to the longitudinal edges.

Preferably, the contact plates are bonded by welding by the longitudinal edges along the linear contact zone. As described in WO 2017/215900 A1, such a configuration can be excellent in dealing with the occurrence of large currents.

The contact plates may in turn be connected to poles of the cell, for example a positive and a negative housing pole.

The contact plates may be connected to the longitudinal edges along the linear contact zone via at least one weld seam or via a multitude of weld points. More preferably, the longitudinal edges comprise one or more sections each connected to the contact plates continuously by a weld seam over their entire length. The longitudinal edges are optionally welded to the contact plate continuously over their entire length.

The welding of the contact plates to the longitudinal edges can give rise to the problems mentioned at the outset, namely the unintentional pressing-down or melting of edge regions of the current collectors. These problems are counted by the support material. It supports the edges of the current collectors mechanically and prevents melting of the edges, especially when the current collectors are coated with the support material on both sides. In addition, the support material also prevents short circuits that result from the melting of separators, mentioned at the outset, of the electrode-separator composite. The support material electrically insulates the clear regions covered therewith. It is thus electrically insulating in preferred embodiments.

The contact plates are preferably metal plates having a thickness of 200 μm to 1000 μm, preferably 400-500 μm. They preferably consist of aluminum, an aluminum alloy, titanium, a titanium alloy, nickel, a nickel alloy, stainless steel or nickel-plated steel. They preferably consist of the same materials as the current collectors to which they are welded.

The contact plates preferably each have at least one slot and/or at least one perforation. The slots and/or perforations ensure that the contact plate does not warp in the event of welding operations. Furthermore, it is ensured that the contact plate does not prevent the ingress of electrolyte into the wound or stacked electrode-separator composite.

Preferably, the contact plates are in the form of a disk, especially in the form of a circular or at least approximately circular disk. In that example, they thus have an outer circular or at least approximately circular disk edge. An approximately circular disk shall be understood here in particular to mean a disk having the shape of a circle with at least one circle segment removed, preferably with two to four circle segments removed.

Further preferably, the contact plates may also have the shape of a polygon, preferably a regular polygon, especially a regular polygon having 4 to 10 vertices and sides.

Especially in a lithium ion cell, the cell is preferably configured as a cylindrical round cell. In that example, it comprises a cylindrical housing including the electrode-separator composite of a winding comprised by the cell. Cylindrical round cells have a height greater than their diameter. They are especially suitable for applications in the automotive sector, for electric bikes or else for other applications with a high energy demand.

The clear region or the subregions may be wholly or partly coated with the support material. The at least one edge that separates the flat sides and hence also the two subregions from one another, by contrast, is preferably not coated with the support material.

Preferably, the height of lithium ion cells in the form of round cells is 15 mm to 150 mm. The diameter of the cylindrical round cells is preferably 10 mm to 50 mm. Within these ranges, particular preference is given to form factors of, for example, 18×65 (diameter by height in mm) or 21×70 (diameter by height in mm). Cylindrical round cells having these form factors are especially suitable for power supply of electrical drives of motor vehicles.

The nominal capacity of the lithium ion cell of the invention in the form of a cylindrical round cell of preferably up to 6000 mAh. With the form factor of 21×70, the cell, in one example as a lithium ion cell, preferably has a nominal capacity is 2000 mAh to 5000 mAh, more preferably 3000 to 4500 mAh.

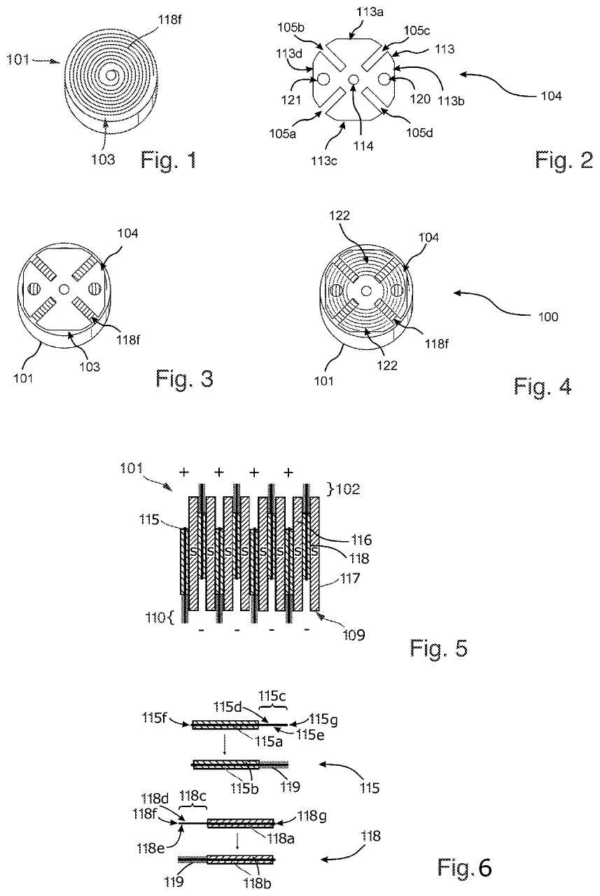

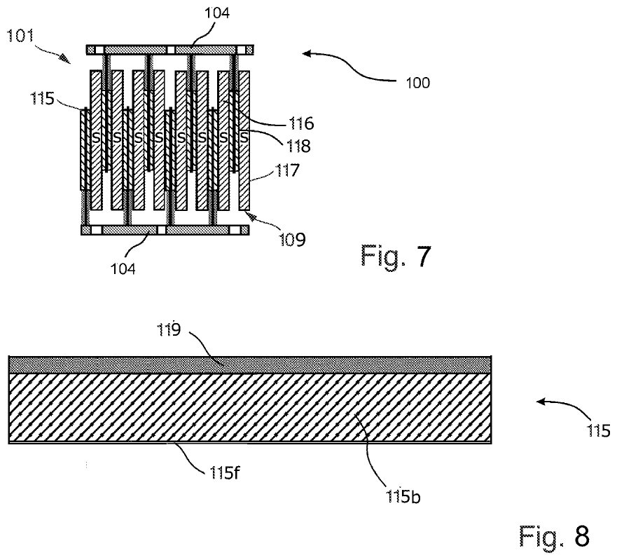

In some configurations, the cell may also be a button cell, especially a lithium ion button cell, having a metallic housing composed of two housing parts insulated from one another by an electrically insulating seal, for example, as shown in FIG. 1 of DE '800. In that configuration, the contact plate may be connected, for example, to the positively polarized half of the housing. Button cells are in cylindrical form and have a height lower than their diameter. The height is preferably 4 mm to 15 mm. It is further preferable that the button cell has a diameter of 5 mm to 25 mm. Button cells are suitable for supply of small electronic devices such as watches, hearing aids and wireless headphones with electrical energy.

The nominal capacity of a lithium ion cell in the form of a button cell is generally up to 1500 mAh. The nominal capacity is preferably 100 mAh to 1000 mAh, more preferably 100 to 800 mAh.

In the European Union, manufacturer data for figures relating to the nominal capacities of secondary batteries are strictly regulated. For instance, figures for the nominal capacity of secondary nickel-cadmium batteries have to be based on measurements according to standards IEC/EN 61951-1 and IEC/EN 60622, figures for the nominal capacity of secondary nickel-metal hydride batteries on measurements according to standard IEC/EN 61951-2, figures for the nominal capacity of secondary lithium batteries on measurements according to standard IEC/EN 61960, and figures for the nominal capacity of secondary lead-acid batteries on measurements according to standard IEC/EN 61056-1. Any figures for nominal capacities herein are preferably likewise based on these standards.

Our cells alternatively, together with at least one further identical cell, be part of a battery, in which it/they is/are preferably connected in parallel or series to the at least one further identical cell and the two cells further preferably have a common housing and also optionally a common electrolyte.

The method for production of the electrochemical cell described always comprises:
a. providing an anode comprising an anode current collector having a surface that consists of at least one metal and has been laden with at least one layer of a negative active electrode material,
b. providing a cathode comprising a cathode current collector having a surface that consists of at least one metal and has been laden with at least one layer of a positive active electrode material, and
c. manufacturing an electrode-separator composite comprising an anode, at least one separator and a cathode using the anode provided and the cathode provided.
   The manufacture of the electrode-separator composite is preceded or followed by
d. coating a clear region on the surface of the anode current collector that has not been laden with the negative active electrode material and/or a clear region on the surface of the cathode current collector that has not been laden with the positive active electrode material with a support material of greater thermal stability than the surface coated therewith.

The materials and cell constituents used in the method have already been described in the description of the cell. Reference is hereby made to these remarks.

Preferably, the method has one of the following:
a. the support material is deposited on the clear region(s) from the gas phase,
b. the support material is applied to the clear region(s) as part of a suspension or paste, and
c. the support material is obtained from a sol-gel process.

The preferred procedure for coating of the current collectors with the support material depends on the type of support material. The deposition from the gas phase can be effected, for example, by means of a CVD or PVD method (CVD=chemical vapor deposition, CVD=physical vapor deposition) or a variant of these methods (for example by means of atomic layer deposition, ALD method). Whereas the material to be deposited in the PVD method is often as such already in the gas phase in the form of vapor (it is converted to the gas phase by physical methods), chemical compounds of the elements to be deposited (called precursors) are evaporated in the CVD method. These break down at the surface of the substrate to give the desired foil material. In the PVD method, coatings can be formed by vapor deposition, sputtering, ion plating and variants of these processes.

Coatings of aluminum oxide can be produced, for example, proceeding from organometallic aluminum compounds such as trimethylaluminum as precursors. It is also possible in particular by CVD method to produce coatings of titanium carbonitride (TCN) as was mentioned. TiN coatings and Ti—AlN coatings can be produced by PVD. Corresponding procedures are known.

Suspension or paste can be applied by customary coating methods such as spraying methods, dip-coating, printing and extrusion.

Oxidic coatings such as aluminum oxide coatings can additionally also be produced via sol-gel processes known from the literature. Aluminum oxide can be prepared, for example, proceeding from aluminum alkyls such as aluminum tri-sec-butoxide or aluminum triisopropoxide.

It is possible in principle to apply the support material to the current collectors before they are laden with the electrode materials. In this example, it is appropriate to mask the regions of the current collectors that are to be laden with the active electrode materials in a subsequent step. Preferably, however, the support material is applied to current collectors already laden with the active electrode materials. In this case, it is possible, given appropriate masking, to coat only the clear regions mentioned. For processing reasons, however, it may be preferable to coat not just the clear regions with the support material but the electrodes as a whole, i.e. including the layers of the active electrode materials. In this example, there is no need for masking.

In some preferred configurations, the support material, alongside a first broad strip of the respective electrode material, is applied in the clear regions, but does not completely cover the clear regions. Instead, it is applied in the form of a second strip or a second line along a longitudinal edge of anode current collector and/or cathode current collector, while a third strip or a third line of the respective clear region parallel thereto along this longitudinal edge remains uncovered. More preferably, the second strip or the second line separates the first strip of the electrode material from the second strip or the second line.

Further advantages that result from our cells and methods are apparent from the drawings and from the description of the drawings that follows. The examples described hereinafter serve merely for elucidation and a better understanding and should in no way be considered in a limiting manner.

FIGS. 1 and 5 show, in schematic form, in a top view obliquely from above and in cross section, an example of an electrode-separator composite 101 in the form of a spiral winding that can be processed to give a cell 100. The winding has two terminal end faces 103 and 109, only one of which, end face 103, is visible in FIG. 1. The electrode-separator composite 101 comprises the anode 115 in strip form and the cathode 118 in strip form, which are separated from one another by the separators 116 and 117 in strip form.

The two terminal end faces 103 and 109 are formed by the longitudinal edges of the separators 116 and 117 in strip form. Within the electrode-separator composite 100, the electrodes 115 and 118 are arranged offset from one another, such that a longitudinal edge of the anode 115 projects from one of the end faces and forms the excess 110, while a longitudinal edge of the cathode 118 projects from the opposite end face and forms the excess 102.

FIG. 6 illustrates the construction of the winding shown in FIGS. 1 and 5. What is shown here is a cross section through the anode 115 and the cathode 118, and a precursor of each of the two electrodes 115 and 118. The precursors differ from the electrodes 115 and 118 merely in that the latter each have a coating of the support material 119. Like the electrodes 115 and 118, they comprise the anode current collector 115a and the cathode current collector 118a. The anode current collector 115a is a copper foil. The cathode current collector 118a is an aluminum foil. The foils each have two flat sides 115d, 115e, and 118d, 118e, which are separated from one another by the longitudinal edges 115f, 115g, and 118f, 118g, and are each laden on either side with a layer 115b; 118b of active electrode materials.

The surface of the anode current collector 115a and the surface of the cathode current collector 118a each comprise a clear region 115c; 118c in strip form, not laden with the respective active electrode material. These clear regions each comprise two subregions in strip form on the two flat sides 115d, 115e of the anode current collector 115a and the two flat sides 118d, 118e of the cathode current collector 118a. These subregions, in the electrodes of the winding 101, are each coated with a layer of aluminum oxide as support material 119. The longitudinal edges 118f and 115g themselves are free of the support material 119.

The clear regions 115c and 118c, by virtue of the support material 119 applied to both sides, are more stable to mechanical and thermal stresses. Furthermore, the support material 119 electrically insulates the regions 115c and 118c.

A top view of the anode 115 shown in cross section in FIG. 6 is shown in FIG. 8.

In the electrode-separator composite 101 in the form of a winding shown in FIGS. 1 and 5, the longitudinal edge 115g of the anode current collector 115a together with the clear region 115c coated with the support material 119 protrudes from the terminal end face 109. The longitudinal edge 118f of the cathode current collector 118a together with the clear region 118c protrudes from the terminal end face 103. The protruding longitudinal edges 115g and 118f, as a consequence of the spiral winding of the electrode-separator composite 101, likewise have a spiral geometry.

For production of the cell 100, two contact plates 104 are laid flat onto the end faces 103 and 109 of the winding. FIG. 3 shows the laying of the contact plate 104 onto the end face 103. This results in linear contact zones between the contact plates and the longitudinal edges 115g and 118f that protrude from the end faces 103 and 109. The contact plates are joined by welding to the longitudinal edges 115g and 118f along the linear contact zone. This makes it possible to electrically contact the current collectors 115a and 118a over their entire length.

The contact plates 104 are shown in FIG. 2. They take the form of approximately spherical disks. They are only approximately spherical because the disk edge 113 departs from a perfect circular geometry at four points 113a to 113d, at each of which a flat circular segment has been removed. The contact plate 104 has the slots 105a, 105b, 105c and 105d. The four slots are aligned proceeding from the outer disk edge 113 radially in the direction of the center of the contact plate. In its center, the contact plate 104 has a passage 114 in the form of a circular hole. There are two further passages 120 and 121 to the right and left of the central opening 114. These can serve as positioning aids in the mounting of the contact plate 104.

The outcome of the welding is shown in FIGS. 4 (top view obliquely from above) and 7 (cross section). The contact plate 104 and the longitudinal edge 118f are connected via the weld seam 122. The latter here has the same spiral profile as the longitudinal edge 118f. The weld seam 122 exactly follows the spiral profile of the longitudinal edge 118f. However, on account of the slots 105a to 105d, it is not possible for the longitudinal edge 118f to be welded to the contact plate 104 continuously over its entire length. Instead, the longitudinal edge 118f—interrupted by the slots 105a to 105d—has a multitude of sections each connected continuously over their entire length to the contact plate 104 along the contact zone via the weld seam 122.

1-14. (canceled)

15. An electrochemical cell comprising:
an electrode-separator composite having an anode, at least one separator and a cathode, wherein
the anode comprises an anode current collector having a surface consisting of at least one metal and has been laden with at least one layer of a negative active electrode material,
the cathode comprises a cathode current collector having a surface consisting of at least one metal and has been laden with at least one layer of a positive active electrode material, and
the surface of the anode current collector and/or the surface of the cathode current collector comprises at least one clear region not laden with the respective active electrode material, and
in the at least one clear region the surface of the anode current collector and/or the surface of the cathode current collector has been coated with a support material of greater thermal stability than the surface coated therewith.

16. The electrochemical cell as claimed in claim 15, wherein:
the at least one metal of which the surface of the anode current collector is at least one selected from the group consisting of copper, a copper alloy, titanium, a titanium alloy, nickel, a nickel alloy and stainless steel,
the anode current collector consists of the at least one metal,
the anode current collector is a metal foil, a metal sponge, a textile fabric or an expanded metal,
the at least one metal of which the surface of the cathode current collector is at least one selected from the group consisting of aluminum, an aluminum alloy, titanium, a titanium alloy and stainless steel,
the cathode current collector consists of the at least one metal, and
the cathode current collector is a metal foil, a metal sponge, a textile fabric or an expanded metal.

17. The electrochemical cell as claimed in claim 15, wherein:
the anode current collector has two flat sides separated from one another by at least one edge,
the anode current collector is laden with the at least one layer of the negative active electrode material on the two flat sides,
the at least one clear region comprises two subregions on the two flat sides of the anode current collector, and
the two subregions of the anode current collector are coated with the support material.

18. The electrochemical cell as claimed in claim 15, wherein:
the cathode current collector has two flat sides separated from one another by at least one edge,
the cathode current collector is laden with the at least one layer of the positive active electrode material on the two flat sides,
the at least one clear region comprises two subregions on the two flat sides of the cathode current collector, and
the two subregions of the cathode current collector are coated with the support material.

19. The electrochemical cell as claimed in claim 15, wherein:
the support material is a nonmetallic material,
the nonmetallic material is a ceramic material, a glass-ceramic material or a glass, and
the ceramic material is aluminum oxide (Al₂O₃) or titanium oxide (TiO₂).

20. The electrochemical cell as claimed in claim 15, wherein:
the electrode-separator composite is a winding with two terminal end faces,
the electrode-separator composite and the at least one separator comprised therein, the electrodes comprised therein and the anode current collector and the cathode current collector are in strip form and each have two longitudinal edges,
the two terminal end faces of the electrode-separator composite are formed by the longitudinal edges of the at least one separator,
both the surface of the anode current collector and the surface of the cathode current collector comprise a clear region not laden with active electrode material,
the clear region on the surface of the anode current collector is an edge region in strip form along one of its two longitudinal edges,
the clear region on the surface of the cathode current collector is an edge region in strip form along one of its two longitudinal edges, and
the anode in strip form and the cathode in strip form are arranged offset from one another within the electrode-separator composite such that
the longitudinal edge of the anode current collector together with the clear region of the anode current collector protrudes from one of the two terminal end faces, and
the longitudinal edge of the cathode current collector together with the clear region of the cathode current collector protrudes from the other of the two terminal end faces.

21. The electrochemical cell as claimed in claim 15, wherein:
the electrode-separator composite, together with at least one further identical electrode-separator composite, is part of a stack in which the at least two electrode-separator composites are stacked one on top of another,
the at least two electrode-separator composites and their anodes, cathodes and separators and their anode current collectors and the cathode current collectors each have at least one longitudinal edge,
the anode current collectors each have a clear region along their longitudinal edge or one of their longitudinal edges,
the cathode current collectors each have a clear region along their longitudinal edge or one of their longitudinal edges, and
the anodes and the cathodes of the at least two electrode-separator composites are arranged offset from one another within the stack such that
the clear regions of the anode current collectors overlap on one side of the stack, and
the clear regions of the cathode current collectors overlap on a further side of the stack.

22. The electrochemical cell as claimed in claim 15, wherein:
the coating of the at least one clear region with the support material has a thickness of 0.015 to 1.0 mm,
the at least one layer of the negative electrode material on the anode current collector has a thickness of 0.03 to 1.0 mm,
the at least one layer of the positive electrode material on the cathode current collector has a thickness of 0.03 to 1.0 mm, and
the thickness of the coating with the support material on the anode current collector or cathode current collector is 50% to 100% of the thickness of the layer of the electrode material present thereon.

23. The electrochemical cell as claimed in claim 16, wherein:
the cell comprises a first electrical conductor welded onto the edge of the anode current collector, and
the cell comprises a second electrical conductor welded onto the edge of the cathode current collector.

24. The electrochemical cell as claimed in claim 23, wherein:
the first electrical conductor is welded onto the longitudinal edge of the anode current collector in strip form, along which the clear region of the anode current collector extends, and
the second electrical conductor is welded onto the longitudinal edge of the cathode current collector in strip form, along which the clear region of the cathode current collector extends.

25. The electrochemical cell as claimed in claim 24, wherein:
the first electrical conductor is a metallic contact plate,
the second electrical conductor is a metallic contact plate,
the first metallic contact plate lies flat against the end face of the winding from which the longitudinal edge to which the contact plate is welded protrudes, and
the second metallic contact plate lies flat against the end face of the winding from which the longitudinal edge to which the contact plate is welded protrudes.

26. A battery comprising at least two of the electrochemical cells as claimed in claim 15.

27. A method of producing the electrochemical cell as claimed in claim 15, comprising:
a. providing an anode comprising an anode current collector having a surface that consists of at least one metal and has been laden with at least one layer of a negative active electrode material,
b. providing a cathode comprising a cathode current collector having a surface that consists of at least one metal and has been laden with at least one layer of a positive active electrode material, and
c. manufacturing an electrode-separator composite comprising an anode, at least one separator and a cathode using the anode provided and the cathode provided, wherein c) is preceded or followed by
d. coating a clear region on the surface of the anode current collector that has not been laden with the negative active electrode material and/or a clear region on the surface of the cathode current collector that has not been laden with the positive active electrode material with a support material of greater thermal stability than the surface coated therewith.

28. The method as claimed in claim 27, wherein:
the support material is deposited on the clear region(s) from the gas phase, and
the support material is applied to the clear region(s) as part of a suspension or paste.
